(19) United States
(12) Patent Application Publication
(10) Pub. No.: US 2026/0116190 A1
(43) Pub. Date: Apr. 30, 2026

(54) DISPLAY DEVICE

(71) Applicant: Sharp Display Technology Corporation, Kameyama City (JP)

(72) Inventor: Masashi MAYUMI, Kameyama City (JP)

(21) Appl. No.: 19/363,796

(22) Filed: Oct. 21, 2025

(30) Foreign Application Priority Data
Oct. 24, 2024 (JP) 2024-187819

(51) Int. Cl. B60K 35/29; B60K 35/28

(52) U.S. Cl. CPC B60K 35/29; B60K 35/285; B60K 2360/1434; B60K 2360/186; B60K 2360/48

(57) ABSTRACT

Provided is a display device including a multi-view display in which a first display image is selectively visually perceivable by a first operator from a first direction and a second display image is selectively visually perceivable by a second operator from a second direction, a touch panel, a proximity sensor, and a control device. The control device determines a proximity position of an indicator on a screen and a proximity direction of the indicator to the screen on the basis of detection signals from the proximity sensor, corrects a display image visually perceivable from a direction other than the proximity direction on the basis of the proximity position in a display image visually perceivable from the proximity direction, and displays a corrected composite image on the screen.

### CROSS-REFERENCE TO RELATED APPLICATIONS

This application claims the benefit of priority to Japanese Patent Application Number 2024-187819 filed on Oct. 24, 2024. The entire contents of the above-identified application are hereby incorporated by reference.

### BACKGROUND

### Technical Field

The disclosure relates to a display device.

A display device mounted in a vehicle is increasing in size by being integrated with measurement meters such as a speedometer or a tachometer disposed in a known instrument panel, and the amount of information displayed on the display device is also increasing by the integration with the measurement meters.

On the other hand, in order to improve the user-friendliness and comfort for a passenger sitting in a passenger seat, there is a demand for displaying a video or content associated with a smartphone possessed by the passenger. However, there is a possibility that such content may potentially impact the driver's driving. In view of this, it is proposed to display different images to the driver and the passenger by utilizing the fact that the direction in which the driver views a display device is different from the direction in which the passenger views the display device (for example, WO 2015/083266). Such a display device is called a multi-view display (multi-view directional display).

### SUMMARY

In a case where the display device includes a touch panel and also serves as an input device, if images displayed to the driver and the passenger are different from each other, for example, the driver cannot perceive what kind of touch operation the passenger performs according to the image.

An object of the disclosure is to provide a display device that includes a touch panel and a multi-view display and enables a person not operating the touch panel to perceive the touch operation content.

A display device according to an embodiment of the disclosure includes a multi-view display configured to, by displaying a composite image including a first display image and a second display image different from each other on a screen, make the first display image selectively perceivable by a first operator from a first direction and make the second display image selectively perceivable by a second operator from a second direction; a touch panel disposed at least partially on or in the multi-view display, the touch panel being configured to detect a touch position of an indicator on the screen; a proximity sensor including a plurality of detection electrodes disposed on the multi-view display, the proximity sensor being configured to detect an approach of the indicator; and a control device, wherein the control device, on a basis of a detection signal from the plurality of detection electrodes, determines a proximity position of the indicator on the screen and a proximity direction of the indicator to the screen, and, on a basis of the proximity position in a display image perceivable from the proximity direction, corrects a display image perceivable from a direction other than the proximity direction and displays a corrected composite image on the screen.

According to an embodiment of the disclosure, a display device is provided that includes a touch panel and a multi-view display and enables a person not operating the touch panel to perceive the touch operation content.

### BRIEF DESCRIPTION OF DRAWINGS

The disclosure will be described with reference to the accompanying drawings, wherein like numbers reference like elements.

FIG. 1 is a schematic view illustrating an instrument panel of a vehicle mounted with a display device.

FIG. 2 is a block diagram illustrating an embodiment of the display device.

FIG. 3 is a schematic cross-sectional view illustrating an embodiment of the display device.

FIG. 4 is a plan view illustrating an arrangement of pixels.

FIG. 5 is a plan view illustrating the positional relationship between pixels and light blocking portions.

FIG. 6 is a schematic view for describing generation of an image to be displayed on a multi-view display.

FIG. 7 is a schematic view for describing how an image is viewed on the multi-view display.

FIG. 8 is a schematic view for describing detection of a proximity position and a proximity direction of a finger by a proximity sensor.

FIG. 9 is a flowchart for describing the operations of the display device.

FIG. 10A illustrates an example of an image of the display device presented to a driver (first operator).

FIG. 10B illustrates an example of an image of the display device presented to a passenger (second operator).

FIG. 11A illustrates an example of an image of the display device presented to a driver.

FIG. 11B illustrates an example of an image of the display device presented to a passenger.

FIG. 12A illustrates an example of an image of the display device presented to a driver.

FIG. 12B illustrates an example of an image of the display device presented to a passenger.

FIG. 13A illustrates an example of an image of the display device presented to a driver.

FIG. 13B illustrates an example of an image of the display device presented to a passenger.

FIG. 14 is a schematic view for describing a detection region for driving a portion of a touch panel.

### DESCRIPTION OF EMBODIMENTS

Embodiments of the disclosure will be described below with reference to the drawings. The disclosure is not limited to the following embodiments, and appropriate design changes can be made within a scope that satisfies the configuration of the disclosure. Further, in the description below, the same reference signs may be used in common among the different drawings for the same portions or portions having the same or similar functions, and descriptions of repetitions thereof may be omitted. Further, the configurations described in the embodiments and the modified examples may be combined or modified as appropriate within a range that does not depart from the gist of the disclosure. For ease of explanation, in the drawings referenced below, configurations may be simplified or schematically illustrated, or a portion of the components may be omitted. Further, dimensional ratios between components illustrated in the drawings are not necessarily indicative of actual dimensional ratios.

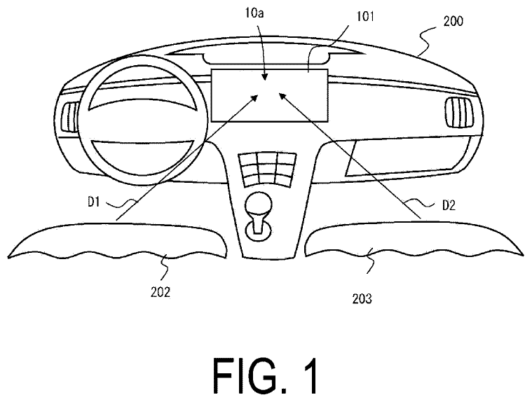

FIG. 1 is a schematic view illustrating an instrument panel 200 of a vehicle in which a display device 101 of the present embodiment is mounted. The instrument panel 200 is located at the front of the interior of the vehicle.

The display device 101 is disposed, for example, at the center of the instrument panel 200. In the present embodiment, the display device 101 is an information display terminal and can display various types of information of the vehicle, an operation screen for the vehicle, a surrounding image captured by an in-vehicle camera, a map used in a car navigation system, traffic information, an operation screen, a screen of an application using various types of information that can be acquired through the Internet line, and the like. The display device 101 may also display a jacket of music content being played, music videos, movies, sports, and similar entertainment content.

The instrument panel 200 is disposed in front of a driver seat 202 and a passenger seat 203, and the display device 101 is disposed at the center of the instrument panel 200 in the horizontal direction. Thus, a first direction D1 and a second direction D2 when the driver in the driver seat 202 and the passenger in the passenger seat 203 view a screen 10a of the display device 101 are different from each other.

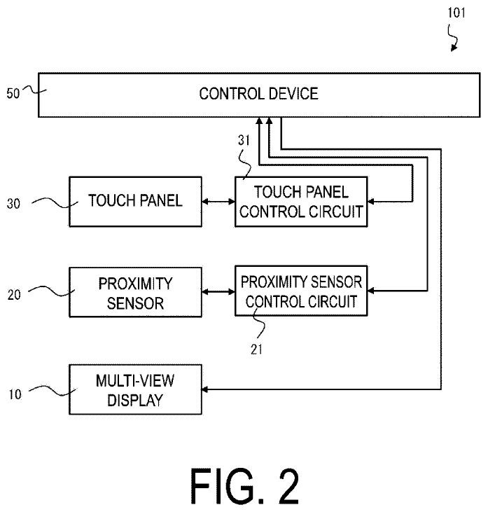

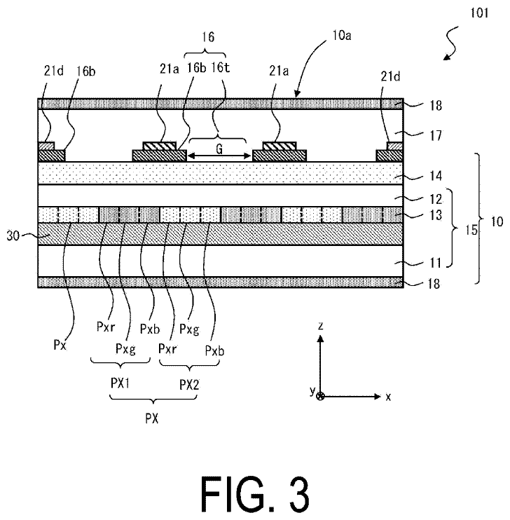

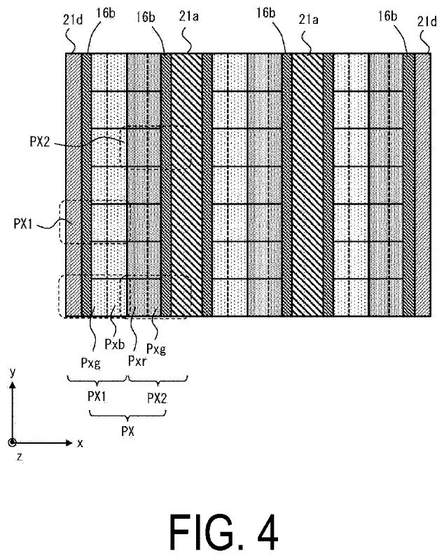

FIG. 2 is a block diagram illustrating an embodiment of the display device 101, and FIGS. 3 and 4 are a schematic cross-sectional view and a plan view of the display device 101.

The display device 101 includes a multi-view display 10, a proximity sensor 20, a touch panel 30, and a control device 50. The display device 101 further includes a proximity sensor control circuit 21 and a touch panel control circuit 31.

The multi-view display 10 is a multi-view directional display that can simultaneously display a plurality of different images according to viewing angles. In the disclosure, the multi-view display 10 can simultaneously display different images when viewed from at least two different directions including the first direction D1 and the second direction D2. Such a multi-view display can be configured by disposing a parallax barrier on a display panel having pixels arranged two-dimensionally, as disclosed in, for example, JP 2015-38532, U.S. Pat. No. 7,580,186, and the like.

In the present embodiment, the multi-view display 10 is, for example, a liquid crystal display, and there is no particular limitation on the driving method. The size of the multi-view display 10 is not particularly limited, and the size can be determined according to the application.

The multi-view display 10 includes an active matrix substrate 11, a counter substrate 12, a liquid crystal layer 13, an adhesive layer 14, a parallax barrier 16, and a protection layer 17.

The liquid crystal layer 13 is disposed between the active matrix substrate 11 and the counter substrate 12, and the active matrix substrate 11, the counter substrate 12, and the liquid crystal layer 13 constitute the display panel 15. The display panel 15 includes a plurality of pixels Px arranged two-dimensionally in a row direction which is an x-axis direction and a column direction which is a y-axis direction.

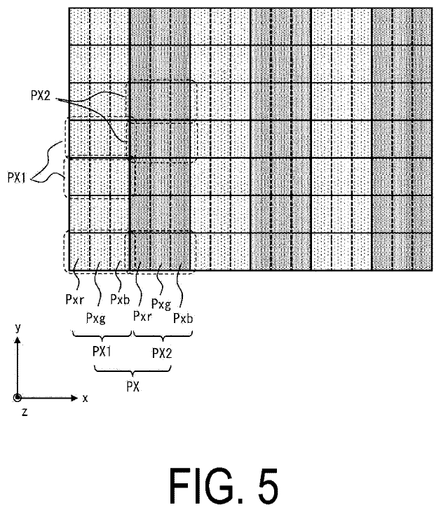

FIG. 5 is a plan view illustrating the arrangement of the plurality of pixels Px. The plurality of pixels Px are classified into red pixels Rxr, green pixels Pxg, and blue pixels Pxb by color filters provided on the active matrix substrate 11 or the counter substrate 12. For example, the red pixel Rxr, the green pixel Pxg, and the blue pixel Pxb are arranged in the row direction, and these three pixels constitute one color pixel PX capable of full color display. Pixels of the same color are arranged in the column direction. The color pixel PX may be simply referred to as a pixel, and each of the red pixel Pxr, the green pixel Pxg, and the blue pixel Pxb constituting the color pixel PX may be referred to as a subpixel.

The color pixel PX includes a first color pixel PX1 and a second color pixel PX2, and the first color pixel PX1 and the second color pixel PX2 are alternately arranged in the row direction. In the column direction, the first color pixels PX1 are arranged continuously, and the second color pixels PX2 are arranged continuously. Thus, the columns of the first color pixels PX1 and the columns of the second color pixels PX2 are alternately arranged in the row direction.

The adhesive layer 14 is disposed on the counter substrate 12, and the parallax barrier 16 is disposed on the adhesive layer 14. The parallax barrier 16 includes a plurality of light blocking portions 16b. Each of the plurality of light blocking portions 16b has a stripe shape extending in the column direction, with a predetermined gap G disposed between them in the row direction. The light blocking portions 16b are made of a light blocking material such as black matrix or the like. Thus, the parallax barrier 16 includes a light transmitting slit 16t located between the plurality of light blocking portions 16b. The array pitch of the light blocking portions 16b in the row direction is equal to, for example, the array pitch of the first color pixels PX1 in the row direction and the array pitch of the second color pixels PX2 in the row direction.

In the present embodiment, the touch panel 30 is disposed inside the multi-view display 10. The touch panel 30 detects the position touched by a finger or the like on the screen 10a of the display device 101. The touch panel 30 may be any of various types of touch panels such as electrostatic capacitive, resistive, surface acoustic wave, and infrared touch panels. The touch panel 30 may be disposed on the multi-view display 10 in any one of an in-cell system, an on-cell system, and an out-cell system. That is, a part or entirety of the touch panel 30 may be disposed on the upper surface of the multi-view display 10, or a part or entirety of the touch panel 30 may be disposed inside the multi-view display 10.

In addition, the touch panel 30 may be a touch panel that detects a position and a magnitude of pressing. The touch panel 30 includes, for example, a driving electrode, a position sensing electrode, and a pressing sensing electrode, applies a drive signal to the driving electrode, detects a change in capacitance caused by contact of a finger or the like using the position sensing electrode, and detects a change in capacitance caused by the pressing of a finger or the like using the pressing sensing electrode. Such a touch panel 30 is disclosed in, for example, JP 2021-128511 A. The disclosure of JP 2021-128511 A is incorporated herein by reference.

The proximity sensor 20 includes a plurality of detection electrodes 21a. Each detection electrode 21a has a stripe shape extending in the row direction and is disposed on one of the plurality of light blocking portions 16b of the parallax barrier 16. The detection electrodes 21a function as an electrostatic capacitive proximity sensor.

The proximity sensor 20 detects the approach and the proximity position of a finger, which is an indicator of the operator, before the finger touches the multi-view display 10. Since the gap G between the light blocking portions 16b is sufficiently small with respect to the finger, the detection electrodes 21a may not be disposed on all the light blocking portions 16b. For example, in the example illustrated in the drawing, the detection electrodes 21a are disposed a pair of the light blocking portions 16b adjacent to each other in the row direction, and the pair of the detection electrodes 21a are arranged in the row direction at a pitch larger than the gap G. By disposing the detection electrodes 21a on the plurality of light blocking portions 16b adjacent to each other in the row direction, even when an abnormality is found in the detection signal obtained from one of the detection electrodes 21a, the average of the detection signals from the other detection electrodes 21a is obtained, and the effects of the abnormality can be reduced.

The proximity sensor 20 detects the approach of the finger by the electrostatic capacitance method, and thus, there is a possibility that the operation of the touch panel 30 is affected. Thus, it is preferable that the detection electrodes 21a are provided only on some of the light blocking portions 16b. The touch panel 30 is less likely to be affected by a change in electrostatic capacitance caused by the proximity sensor 20 below the light blocking portions 16b where the detection electrodes 21a are not located.

Dummy electrodes 21d may be provided on the light blocking portions 16b where the detection electrodes 21a are not located. The detection electrodes 21a are connected to the proximity sensor control circuit 21, and the dummy electrodes 21d are floating electrodes that are not connected to other circuits, a reference potential, a ground potential, or the like. Alternatively, the dummy electrodes 21d may also not be disposed in the light blocking portions 16b where the detection electrodes 21a are not located. In any case, the number of the detection electrodes 21a is less than the number of the light blocking portions 16b.

A protection layer 17 is disposed on the adhesive layer 14 covering the light blocking portions 16b and the detection electrodes 21a. A pair of polarizers 18 are disposed outside the protection layer 17 and the active matrix substrate 11.

The touch panel control circuit 31 periodically outputs a drive signal to the electrodes of the touch panel 30 and receives a detection signal from the touch panel 30 in order to detect a touch on the screen 10a by the operator. The touch panel control circuit 31 outputs a detection signal to the control device 50 at a predetermined cycle.

The proximity sensor control circuit 21 periodically outputs a drive signal to the proximity sensor 20 and receives a detection signal from the proximity sensor 20 in order to detect the approach of the operator to the screen 10a.

The control device 50 includes a host computer and controls the proximity sensor control circuit 21 and the touch panel control circuit 31. Specifically, the control device 50 receives a detection signal from the proximity sensor 20 from the proximity sensor control circuit 21 and determines the proximity position of the finger to the screen 10a and the proximity direction of the finger to the screen 10a. The control device 50 receives a detection signal from the touch panel control circuit 31 at a predetermined cycle and determines the detection position of the finger.

The control device 50 further generates an image to be displayed on the multi-view display 10. This image is a composite image including a first display image selectively visually perceivable by a first operator who views the screen 10a of the multi-view display 10 from the first direction D1 and a second display image selectively visually perceivable by a second operator who views the screen 10a of the multi-view display 10 from the second direction D2. Here, “selectively” means that the image is difficult to be visually perceived by another operator. Specifically, the first display image is difficult to be visually perceived by the second operator, and the second display image is difficult to be visually perceived by the first operator. The first display image and the second display image are different from each other.

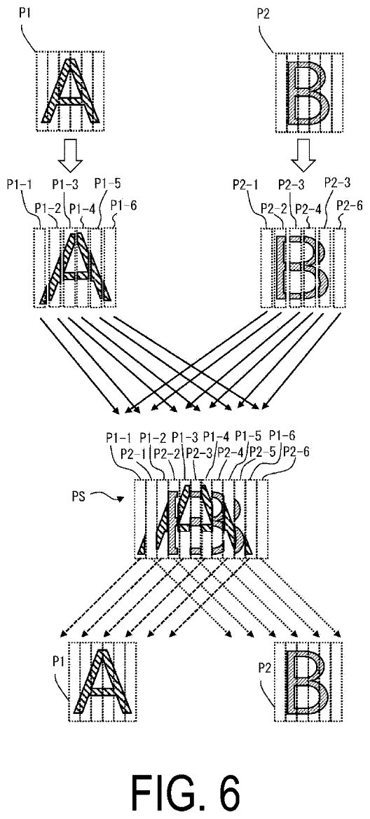

Next, image display by the multi-view display 10 will be described. FIG. 6 is a schematic view for describing generation of an image to be displayed on the multi-view display 10. The control device 50 receives data of a first display image P1 and a second display image P2 from the outside, divides the first display image P1 and the second display image P2, and combines the divided images to generate a composite image PS. For example, the control device 50 generates divided images P1-1 to P1-6 and divided images P2-1 to P2-6 obtained by dividing the first display image P1 and the second display image P2 into predetermined widths in the row direction. The width of the divided images depends on the width of the light blocking portions 16b and the width of the light transmitting slits 16t of the parallax barrier 16 and is equal to, for example, the array pitch of the first color pixel PX1 and the second color pixel PX2 in the row direction. That is, the width of the divided images is equal to the width of the color pixel PX in the row direction.

Further, in the control device 50, the divided images P1-1 to P1-6 and the divided images P2-1 to P2-6 are alternately arranged in the row direction to combine the divided images and generate the composite image PS. The data of the generated composite image PS is output to the multi-view display 10.

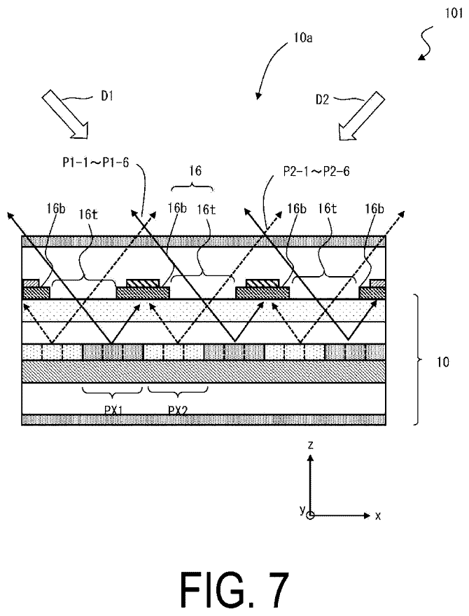

FIG. 7 is a schematic view for describing how an image is viewed on the multi-view display 10. As illustrated in FIG. 7, when the screen 10a of the multi-view display 10 is viewed from the first direction D1, the light emitted from the first color pixel PX1 passes through the light transmitting slits 16t of the parallax barrier 16, but the light emitted from the second color pixel PX2 is blocked by the light blocking portions 16b. Also, when the screen 10a of the multi-view display 10 is viewed from the second direction D2, the light emitted from the second color pixel PX2 passes through the light transmitting slits 16t of the parallax barrier 16, but the light emitted from the first color pixel PX1 is blocked by the light blocking portions 16b.

Thus, the composite image PS is displayed on the multi-view display 10 with the divided images P1-1 to P1-6 of the generated composite image PS are disposed in the first color pixel PX1 and the divided images P2-1 to P2-6 are located in the second color pixel PX2. In this manner, the light of the divided images P1-1 to P1-6 is selectively emitted in the first direction D1 and the light of the divided images P2-1 to P2-6 is selectively emitted in the second direction D2. Thus, the first display image P1 is visually perceivable by the driver (first operator) who views the screen 10a of the multi-view display 10 from the first direction D1, and the second display image P2 is visually perceivable by the passenger (second operator) who views the screen 10a of the multi-view display 10 from the second direction D2.

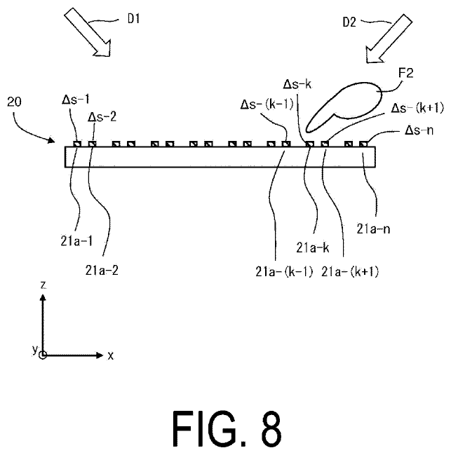

Next, a method of determining the proximity position of the finger to the screen 10a and determining the proximity direction of the finger to the screen 10a by the control device 50 will be described. FIG. 8 is a schematic view for describing detection of the proximity position and the proximity direction of a finger by the proximity sensor. The plurality of detection electrodes 21a are arranged in the screen 10a of the display device 101. The detection signals obtained from the plurality of detection electrodes 21a do not cause a change in electrostatic capacitance unless an object that changes electrostatic capacitance, such as a finger F2, approaches.

On the other hand, when the finger F2 approaches, the distances from the detection electrodes 21a to the finger or palm, which is a dielectric, are different depending on the position, and the amounts of change in electrostatic capacitance detected by the plurality of detection electrodes 21a are also different.

When a finger approaches the screen 10a, the amount of change in the electrostatic capacitance of the detection electrodes 21a approached by the tip of the finger wishing to be brought into contact with the screen is the largest. Normally, when the driver or the passenger touches the screen of the display device 101, a palm or another finger approaches the outer side of the center in the horizontal direction (row direction) of the screen 10a. Thus, by comparing the amounts of change in the electrostatic capacitances obtained from the detection signals detected by each detection electrode 21a, it is possible to determine the proximity position of the finger on the screen 10a and the proximity direction of the finger to the screen 10a. For example, as illustrated in FIG. 8, the plurality of detection electrodes 21a arranged in the row direction are set as detection electrodes 21a-1, 21a-2, . . . , 21a-k, . . . , 21a-n from the driver side to the passenger side. The second direction D2 side, that is, the passenger, performs an operation, and the finger is closest to the detection electrode 21a-k. Further, changes in the detection signals, that is, the amounts of change in the electrostatic capacitance, due to the approach of the finger obtained from the detection electrodes 21a-1, 21a-2, . . . , 21a-k, . . . , 21a-n are denoted by Δs−1, Δs−2, . . . , Δs−k, . . . , Δs−n.

In this case, the amount of change Δs−k in the detection electrode 21a-k to which the finger F2 is closest is the largest. In addition, the amounts of change Δs−1 to Δs−(k−1) are substantially zero as the finger does not approach these, and the amounts of change Δs−(k+1) to Δs−n, to which the palm or another finger may approach, satisfy the relationship of Δs−k>Δs−(k+1) to Δs−n. In this manner, the control device 50 determines the proximity position of the finger and the proximity direction of the finger by comparing the detection signals obtained from the plurality of detection electrodes 21a. The proximity direction corresponds to the operator. Since the detection electrodes 21a have a stripe shape extending in the column direction, the proximity position of the finger is identified in the row direction of the screen 10a, but cannot be identified in the column direction.

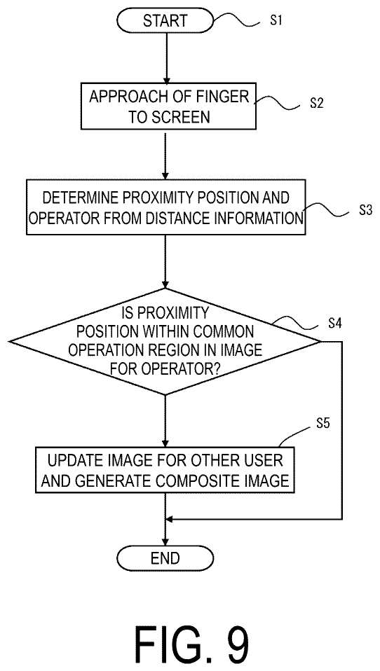

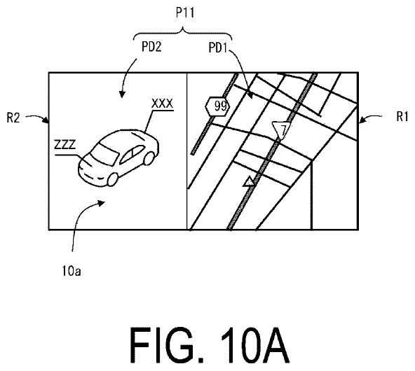

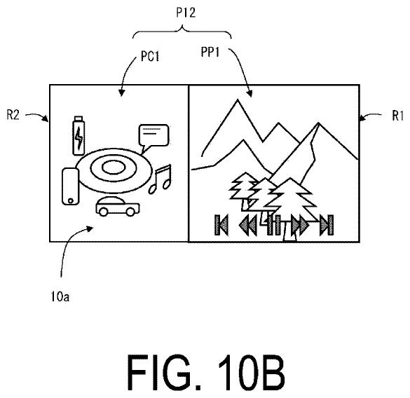

Next, the operations of the display device 101 will be described. FIG. 9 is a flowchart for describing the operations of the display device 101. FIGS. 10A to 13A illustrate examples of images of the display device 101 presented to the driver (first operator), and FIGS. 10B to 13B illustrate examples of images of the display device 101 presented to the passenger (second operator). In these examples, the driver is driving the vehicle.

In the initial state, a first display image P11 and a second display image P12 illustrated in FIGS. 10A and 10B are presented to the driver (first operator) and the passenger (second operator), respectively.

As illustrated in FIG. 10A, the first display image P11 includes, for example, an image PD1 of a map for navigation and an image PD2 showing vehicle information. Since the map for navigation and the vehicle information are mainly information necessary for the driver, the image PD1 is content for the driver. Since the vehicle information is also information mainly necessary for the driver, the image PD2 is also content for the driver. The image PD1 is disposed in a first region R1, and the image PD2 is disposed in a second region R2.

As illustrated in FIG. 10B, the second display image P12 includes, for example, an image PC1 of a menu for performing various operations and an image PP1 of a movie which is content for entertainment viewed by the passenger. The menu for performing various operations is information necessary for both the driver and the passenger and is common content. On the other hand, content such as a movie is content for the second operator in a case where the driver is driving the vehicle. The image PC1 is disposed in the second region R2, and the image PP1 is disposed in the first region R1.

As described above, the control device 50 generates divided images by dividing the first display image P11 including the image PD1 and the image PD2 and the second display image P12 including the image PC2 and the image PP1 by predetermined widths in the row direction and further generates a composite image in which the divided images are alternately arranged. By displaying the generated composite image on the multi-view display 10, the driver who is the first operator views the first display image P11, and the passenger who is the second operator views the second display image P12.

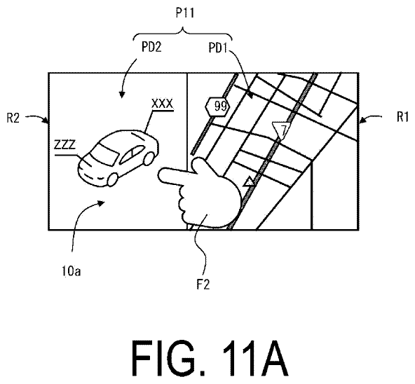

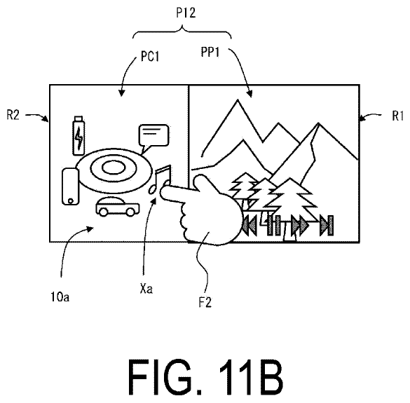

In this state, either the driver or the passenger brings the finger F2 close to the screen 10a in order to perform input to the touch panel 30 of the display device 101 (step S1). In the examples illustrated in FIGS. 11A and 11B, the passenger brings the finger F2 close to the image PC1 of the menu of the second display image P12. At this time, since the driver is looking at the first display image P11 different from the second display image P12, the motion of the finger F2 of the passenger and the first display image P11 do not correspond to each other, and the driver cannot understand what operation the passenger is trying to perform.

The proximity sensor 20 outputs detection signals obtained from the plurality of detection electrodes 21a to the control device 50 at predetermined time intervals. As described above, the control device 50 obtains the distance information between each detection electrode and the approaching dielectric from the detection signal received from the proximity sensor 20. Further, the control device 50 determines the proximity position and the proximity direction, that is, which operator's finger it is, from the distance information of the finger F2 approaching the respective detection electrodes 21a (step S2). In the examples illustrated in FIGS. 11A and 11B, the control device 50 determines that the proximity direction is the second direction and the finger F2 of the passenger is approaching.

Subsequently, the control device 50 determines whether or not the proximity position is within the region of the common content on the screen of the determined operator (step S3). In the examples illustrated in FIGS. 11A and 11B, it is determined that the finger F2 is approaching from the passenger side, and it is determined whether or not the proximity position is the region of the common content in the second display image P12 presented to the passenger.

As illustrated in FIG. 11B, since the finger F2 is approaching from the second direction, the control device 50 determines whether or not a proximity position Xa is within the region of the common content in the second display image P12 visually perceivable by the passenger who is the second operator viewing the display device 101 from the second direction. The proximity position Xa is within the second region R2 where the image PC1 of the menu, which is the common content, is located. Thus, the control device 50 updates the image of the other person and generates a composite image using the updated image (step S4). Specifically, the control device 50 corrects the first display image P11 to include the image PC1 of the menu which is the common content and displays a corrected composite image obtained by combining the corrected first display image P21 and the second display image P12 on the multi-view display 10.

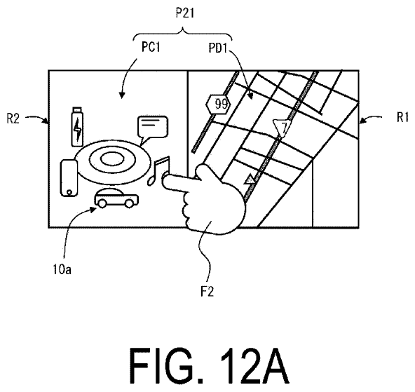

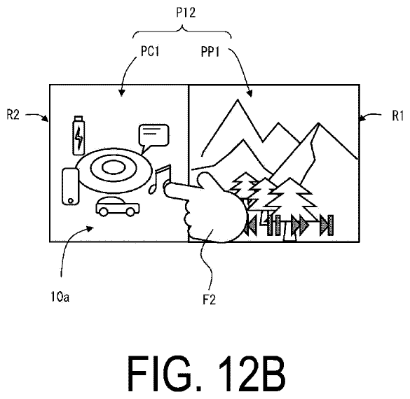

As a result, as illustrated in FIG. 12A, the image PC1 of the menu is disposed in the first region R1 of the first display image P21 visually perceivable by the driver. Thus, the driver can perceive that the position to which the finger F2 of the passenger approaches corresponds to the image PC1 of the menu. On the other hand, as illustrated in FIG. 12B, the second display image P12 is not corrected. Thus, the passenger can operate the menu by touching the image PC1 of the menu with the finger F2.

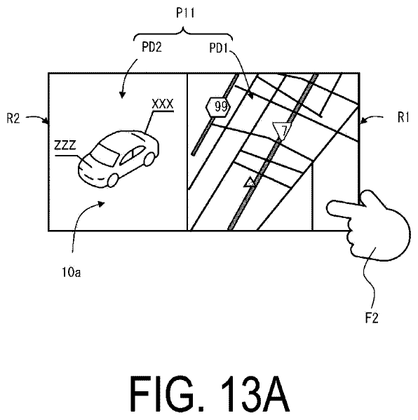

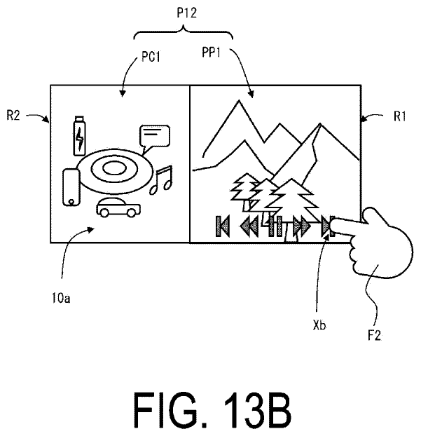

As illustrated in FIG. 13B, the passenger brings the finger F2 close to the image PP1 of the movie of the second display image P12. At this time, as illustrated in FIG. 13A, since the driver is looking at the first display image P11 different from the second display image P12, the motion of the finger F2 of the passenger and the first display image P11 do not correspond to each other, and the driver cannot understand what operation the passenger is trying to perform.

Similarly, the control device 50 obtains distance information from the detection signal received from the proximity sensor 20 and determines the proximity position and the proximity direction from the distance information (step S2). In the examples illustrated in FIGS. 13A and 13B, the control device 50 determines that the proximity direction is the second direction and the finger F2 of the passenger is approaching. Subsequently, the control device 50 determines whether or not the proximity position is within the region of the common content on the screen of the determined operator (step S3). In the examples illustrated in FIGS. 13A and 13B, it is determined that the finger F2 is approaching from the passenger side and it is determined whether or not a proximity position Xb is the region of the common content in the second display image P12 presented to the passenger. The proximity position Xb is within the first region R1 where the image PP1 of a movie, music, or the like, which is content for the driver, is located. Thus, the control device 50 ends the process without changing the image of the other person. That is, the control device 50 displays the composite image of the first display image P11 and the second display image P12 displayed before the approach of the finger F2 on the multi-view display 10 without changing the composite image. As a result, the first display image P11 continues to be visually perceivable to the driver. Thus, the image PP1 of the movie is not presented to the driver who is driving, and information irrelevant to driving is prevented from being presented to the driver.

As described above, according to the display device of the present embodiment, it is possible to determine whether the driver or the passenger is attempting to operate the touch panel by the proximity sensor and to correct the display image visually perceived by the person who is not operating the touch panel on the basis of the determination result. Thus, for example, when the passenger attempts to operate the menu screen that is commonly used by the driver and the passenger and the menu screen is not displayed for the driver, the menu screen can be displayed for the driver as well. In particular, since the driver can see the same menu screen as the passenger, the driver can specifically perceive what operation the passenger intends to use. In addition, when the fellow passenger is watching a movie and attempts to operate the movie, the front image visually perceivable by the driver is not corrected, and an image irrelevant to driving is not displayed to the driver.

Further, according to the display device of the present embodiment, since the detection electrodes of the proximity sensor are disposed on the parallax barrier of the multi-view display, the area of the frame region can be reduced as compared with the case where the proximity sensor is disposed in the frame region. Since the detection electrodes of the proximity sensor are provided in a portion of the light blocking portions of the parallax barrier, the effects on the detection of the touch sensor can be reduced.

In the embodiment described above, the operation of the display device 101 during driving has been mainly described, but when the vehicle is stopped, such as during parking, the driver may operate the display device 101. In this case, the first display image presented to the driver and the second display image presented to the passenger are different from each other, and the second display image may be corrected by the driver bringing their finger close to the screen 10a of the display device 101. During driving or parking, the display device 101 may display the second display image that is the same as the first display image.

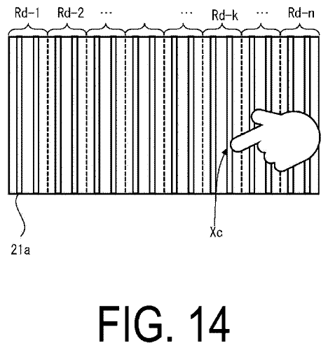

The display device of the disclosure is not limited to the embodiments described above, and various modifications may be performed. For example, in the display device 101, the detection signal of the proximity sensor 20 may be used for controlling the touch panel 30. Specifically, as illustrated in FIG. 14, the screen 10a is divided into detection regions Rd−1, Rd−2, . . . , Rd−k, . . . , Rd−n in the row direction.

The control device 50 determines the proximity position of the finger F2 on the basis of the detection signals from the detection electrodes 21a. For example, when a proximity position Xc is within the detection region Rd−k, only a portion of the touch panel 30 located in the detection region Rd−k is driven, and portions located in the other detection regions are stopped. By performing such control, the power consumption of the touch panel 30 can be reduced.

In the embodiment described above, the multi-view display 10 is a liquid crystal display, but may be a display having another structure such as an organic EL display, a mini LED display, or the like.

The display device of the disclosure can be described as follows.

A display device according to a first configuration includes a multi-view display configured to, by displaying a composite image including a first display image and a second display image different from each other on a screen, make the first display image selectively perceivable by a first operator from a first direction and make the second display image selectively perceivable by a second operator from a second direction; a touch panel disposed at least partially on or in the multi-view display, the touch panel being configured to detect a touch position of an indicator on the screen; a proximity sensor including a plurality of detection electrodes disposed on the multi-view display, the proximity sensor being configured to detect an approach of the indicator; and a control device, wherein the control device, on a basis of a detection signal from the plurality of detection electrodes, determines a proximity position of the indicator on the screen and a proximity direction of the indicator to the screen, and, on a basis of the proximity position in a display image perceivable from the proximity direction, corrects a display image perceivable from a direction other than the proximity direction and displays the composite image corrected on the screen.

According to the first configuration, the proximity position of the indicator and the proximity direction of the indicator to the screen are determined by the detection signal obtained from the proximity sensor. Thus, it is possible to determine whether the first operator or the second operator is attempting to operate the touch panel and to correct the display image visually perceived by the operator who is not operating the touch panel on the basis of the determination result.

A second configuration is based on the first configuration, wherein the first display image includes first content for a first operator, the second display image includes second content for a second operator and common content used in common by the first operator and the second operator, and in a case where the proximity direction is the second direction and the proximity position is in a region in which the common content of the second display image is displayed, the control device corrects the first display image to include the common content and displays the composite image corrected obtained by combining the first display image corrected and the second display image on the screen. According to this configuration, when the second operator attempts to operate the menu screen that is the common content used in common by the first operator and the second operator and the menu screen is not displayed for the first operator, the menu screen can be displayed also for the first operator. Thus, the first operator can specifically perceive what kind of operation the second operator intends to use.

A third configuration is based on the first configuration, wherein the first display image includes first content required by the first operator, the second display image includes second content required by the second operator and common content required in common by the first operator and the second operator, and in a case where the proximity direction is the second direction and the proximity position is in a region in which the second content of the second display image is displayed, the control device displays the composite image unchanged on the screen. According to this configuration, when the second operator is viewing content such as a movie and is attempting to operate the movie, the front image visually perceivable by the first operator is not corrected, and an image irrelevant to driving can be prevented from being displayed to the first operator.

A fourth configuration is based on the first configuration, wherein the multi-view display includes a display panel including a plurality of pixels arranged in a row and column direction, and a parallax barrier including a plurality of light blocking portions and disposed on a front surface of the display panel, the plurality of light blocking portions each having a stripe shape extending in a column direction and being disposed with a predetermined gap therebetween in the row direction,
each of the plurality of detection electrodes of the proximity sensor is disposed at one of the plurality of light blocking portions, and number of the plurality of detection electrodes is less than number of the plurality of light blocking portions. According to this configuration, since the detection electrodes of the proximity sensor are disposed on the parallax barrier of the multi-view display, the area of the frame region can be reduced as compared with the case where the proximity sensor is disposed in the frame region. Also, since the detection electrodes of the proximity sensor are provided in a portion of the light blocking portions of the parallax barrier, the effects on the detection of the touch sensor can be reduced.

A fifth configuration is based on the first configuration, wherein the first direction and the second direction are positioned on either side of a line perpendicular to the screen in a plane perpendicular to the screen of the multi-view display and parallel with the column direction.

A sixth configuration is based on the first configuration, wherein the touch panel includes a plurality of detection regions divided in a row direction, and the control device determines a proximity position of the indicator on the screen on a basis of a detection signal from the plurality of detection electrodes, and detects a touch position of the indicator by driving only a part of the detection regions of the touch panel, on the basis of the proximity position. By performing such control, the power consumption of the touch panel can be reduced.

A seventh configuration is based on the first configuration, wherein the control device displays a composite image obtained by dividing the first display image and the second display image and disposing the first display image divided and the second display image divided in a predetermined order on the screen of the multi-view display.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A display device comprising:
a multi-view display configured to, by displaying a composite image including a first display image and a second display image different from each other on a screen, make the first display image selectively perceivable by a first operator from a first direction and make the second display image selectively perceivable by a second operator from a second direction;
a touch panel disposed at least partially on or in the multi-view display, the touch panel being configured to detect a touch position of an indicator on the screen;
a proximity sensor including a plurality of detection electrodes disposed on the multi-view display, the proximity sensor being configured to detect an approach of the indicator; and
a control device,
wherein the control device
on a basis of a detection signal from the plurality of detection electrodes, determines a proximity position of the indicator on the screen and a proximity direction of the indicator to the screen, and
on a basis of the proximity position in a display image perceivable from the proximity direction, corrects a display image perceivable from a direction other than the proximity direction and displays the composite image corrected on the screen.

2. The display device according to claim 1,
wherein the first display image includes first content for the first operator,
the second display image includes second content for the second operator and common content used in common by the first operator and the second operator, and
in a case where the proximity direction is the second direction and the proximity position is in a region in which the common content of the second display image is displayed, the control device corrects the first display image to include the common content and displays the composite image corrected obtained by combining the first display image corrected and the second display image on the screen.

3. The display device according to claim 1,
wherein the first display image includes first content required by the first operator,
the second display image includes second content required by the second operator and common content required in common by the first operator and the second operator, and
in a case where the proximity direction is the second direction and the proximity position is in a region in which the second content of the second display image is displayed, the control device displays the composite image unchanged on the screen.

4. The display device according to claim 1,
wherein the multi-view display includes
a display panel including a plurality of pixels arranged in a row and column direction, and
a parallax barrier including a plurality of light blocking portions and disposed on a front surface of the display panel, the plurality of light blocking portions each having a stripe shape extending in a column direction and being disposed with a predetermined gap therebetween in the row direction,
each of the plurality of detection electrodes of the proximity sensor is disposed at one of the plurality of light blocking portions, and
number of the plurality of detection electrodes is less than number of the plurality of light blocking portions.

5. The display device according to claim 1,
wherein the first direction and the second direction are positioned on either side of a line perpendicular to the screen in a plane perpendicular to the screen of the multi-view display and parallel with the column direction.

6. The display device according to claim 1,
wherein the touch panel includes a plurality of detection regions divided in a row direction, and
the control device
determines a proximity position of the indicator on the screen on a basis of a detection signal from the plurality of detection electrodes, and
detects a touch position of the indicator by driving only a part of the detection regions of the touch panel, on the basis of the proximity position.

7. The display device according to claim 1,
wherein the control device displays a composite image obtained by dividing the first display image and the second display image and disposing the first display image divided and the second display image divided in a predetermined order on the screen of the multi-view display.
